(19) United States
(12) Patent Application Publication
(10) Pub. No.: US 2009/0071550 A1
(43) Pub. Date: Mar. 19, 2009

(54) IN-LINE ADJUSTABLE REGULATORS

(76) Inventors: Daryll Duane Patterson, N. Brooklyn Park, MN (US); Eric Jacob Burgett, Eden Prairie, MN (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/855,756

(22) Filed: Sep. 14, 2007

(51) Int. Cl. F16K 15/06

(52) U.S. Cl. 137/523

(57) ABSTRACT

Adjustable in-line fluid regulators are described. One described example fluid regulator includes a body having a fluid inlet and a fluid outlet. The example regulator also includes a first fluid regulator having a valve to control the flow of fluid from the inlet to the outlet, a piston coupled to the valve via a stem, wherein the piston is to receive a pressure associated with the outlet. The first fluid valve also includes a spring plate movable along a longitudinal axis of the stem, a spring disposed between the piston and the spring plate, and an adjuster engaged with the body to move the spring plate to change a compression of the spring and a regulated outlet pressure of the fluid regulator.

### FIELD OF THE DISCLOSURE

The present disclosure relates generally to fluid regulators and, more particularly, to in-line adjustable regulators.

### BACKGROUND

Process control systems utilize a variety of field devices to control process parameters. Fluid regulators are commonly distributed throughout process control systems to control the pressures of various fluids (e.g., liquids, gasses, etc.). Fluid regulators are typically used to regulate the pressure of a fluid to a substantially constant value. Specifically, a fluid regulator has an inlet that typically receives a supply fluid at a relatively high pressure, which may vary or fluctuate, and provides a relatively lower and substantially constant pressure at an outlet. For example, a gas regulator associated with a piece of equipment may receive a gas having a relatively high pressure from a gas distribution source and may regulate the gas to have a lower, substantially constant pressure suitable for safe, efficient use by the equipment.

Fluid regulators typically control the flow and pressure of fluid using a diaphragm or piston having a set or control pressure force applied to one of its sides via a bias spring. The diaphragm is also operatively coupled directly or via a linkage to a valve component that is moved relative to an orifice of a seat that fluidly couples the inlet of the regulator to its outlet. The diaphragm or piston moves the valve component in response to a difference between the outlet pressure and the set or control pressure to vary the flow restriction through the regulator to achieve a substantially constant outlet pressure, which provides a balancing force to the other side of the diaphragm or piston that is equal or proportional to the set or control pressure.

Fluid regulators may provide a fixed (e.g., non-field adjustable) regulated output pressure, while other types of fluid regulators may provide one or more adjustments to adjustably set or vary the output pressure. Typically, an adjustable fluid regulator includes a spring that is compressed a predetermined amount to set its regulated output pressure. In some regulators, the amount of compression applied to the spring may be varied or adjusted to enable field adjustment of the regulated output pressure of the regulator. Typically, such field adjustable fluid regulators provide a knob or the like that can be grasped and turned to rotate a threaded rod that, possibly through one or more intervening components, changes a compression of the spring, thereby changing the regulated output pressure of the regulator. However, many of these adjustable regulators require a mounting surface and/or consume a relatively large amount of space, which may be scarce or lacking within control cabinets as well as other spaces in which the regulators are typically located throughout a process control system.

### SUMMARY

In accordance with one described example, an adjustable fluid regulator includes a body having a fluid inlet and a fluid outlet, and a first fluid regulator. The first fluid regulator includes a valve to control the flow of fluid from the inlet to the outlet, and a piston coupled to the valve via a stem, wherein the piston is to receive a pressure associated with the outlet. Additionally, the first fluid regulator includes a spring plate movable along a longitudinal axis of the stem, a spring disposed between the piston and the spring plate, and an adjuster engaged with the body to move the spring plate to change a compression of the spring and a regulated outlet pressure of the fluid regulator.

In accordance with another described example, an adjustable fluid regulator assembly includes a first fluid regulator and a second fluid regulator fluidly coupled to the first fluid regulator. The first and second fluid regulators form an in-line, two-stage fluid regulator. The first fluid regulator comprises an adjuster to change a fluid regulation pressure of the first fluid regulator, and the adjuster is configured to be field adjustable to change a compression of a spring of the first fluid regulator.

### BRIEF DESCRIPTION OF THE DRAWINGS

FIG. 1 depicts a cross-sectional view of a known in-line one-stage fluid regulator.

FIG. 2 depicts a cross-sectional view of an example in-line one-stage adjustable fluid regulator.

FIG. 3 depicts a cross-sectional view of an example in-line two-stage adjustable fluid regulator.

### DETAILED DESCRIPTION

The example fluid regulators described herein provide one-stage or two-stage configurations having excellent regulation characteristics, which minimize the effect of inlet pressure changes on output or outlet pressure. Additionally, the example fluid regulators described herein provide compact configurations having adjustable (e.g., field adjustable) output pressure. The relatively compact configurations in comparison to known fluid regulators facilitates the use of the example fluid regulators described herein within control cabinets as well as other space-constrained process control environments. Also, the example fluid regulators described herein may be used as a compression tie between a piston and a valve, where the tie may be used to apply continuous additional force to produce an airtight seal if the valve should leak. Further, the example fluid regulators described herein may be used in relatively harsh service environments such as, for example, in connection with contaminated fluids, large temperature variations, high inlet pressures (e.g., 10,000 psig), etc.

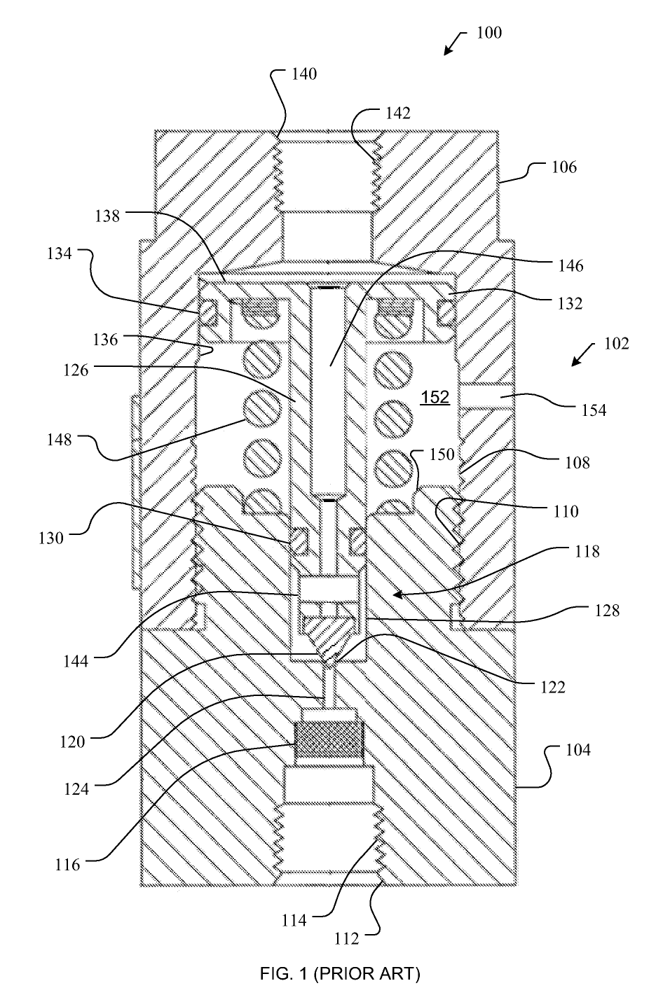

FIG. 1 depicts a cross-sectional view of a known in-line one-stage fluid regulator 100. The known fluid regulator 100 has generally cylindrical body, housing, or casing 102 including a lower casing or first portion 104 and an upper casing, bonnet, or second portion 106. The first and second portions 104 and 106 are threadably engaged via respective mating threads 108 and 110. The first portion 104 includes an inlet port 112 having internal threads 114 to engage a pipe or other fluid carrying conduit. Additionally, a filter or screen 116 is provided in the inlet 112 to prevent dirt and/or other debris from contaminating the regulator and impairing its operation. The first portion 104 also holds or guides a valve assembly 118. The valve assembly 118 includes a fluid flow control member or plug 120 that moves relative to an opening or orifice 122 of a passage 124, which is fluidly coupled to the inlet 112, to control the flow of fluid into the regulator 100. The fluid flow control member or plug 120 is fixed to a stem 126 that is slidably engaged with a bore 128 in the first housing portion 104. An o-ring 130 forms a circumferential seal between the wall of the bore 128 and the stem 126. The stem 126 is integrally formed with a piston 132 that is slidably engaged within the upper or second casing portion 106. An o-ring 134 provides a seal against an inner wall 136 of the upper or second casing portion 106. An upper surface 138 of the piston 132 is fluidly coupled to an outlet pressure port 140, which includes internal threads 142 for receiving a pipe or other fluid conduit.

As can been seen clearly in FIG. 1, the bore 128 is fluidly coupled to the outlet port 140 via passageways 144 and 146. Thus, when the plug 120 is spaced from the orifice 122, fluid can flow from the inlet 112 to the outlet 140 to increase the pressure at the outlet 140. A compression spring 148 is disposed between the piston 132 and a seat 150 of the first or lower casing portion 104. A chamber 152 between the piston 132 and the seat 150 is vented via an opening 154 to the atmosphere and, thus, remains at atmospheric pressure during operation of the regulator 100.

In operation, the spring 148 biases or urges the piston 132 and, thus, the plug 120 away from the orifice 122 so that the valve 118 provides a normally-open configuration. Thus, in the absence of a pressure greater than atmospheric pressure at the outlet 140, the valve 118 is in a fully open condition. Further, as the inlet 112 passes pressurized fluid to the outlet 140, the pressure at the outlet 140 increases and the pressure on the surface 138 of the piston 132 increases and urges the plug 120 toward the orifice 122, thereby restricting the flow of fluid from the inlet 112 to the outlet 140. When the pressure at the outlet 140 is sufficiently high, a force balance condition (i.e., the pressure exerted by the spring will balance against the pressure at the outlet 140) will be achieved so that the pressure at the outlet 140 is at a substantially constant pressure lower than the pressure at the inlet 112. The force balance-based operation of such fluid regulators is well known and, thus, is not described in greater detail herein.

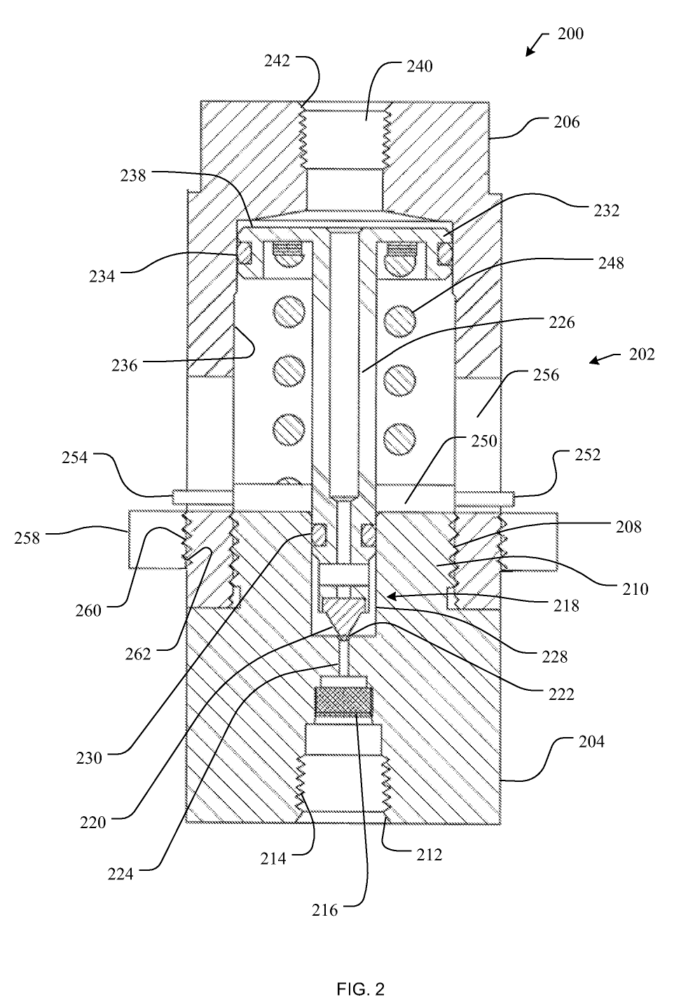

FIG. 2 depicts a cross-sectional view of an example one-stage in-line adjustable fluid regulator 200. The example fluid regulator 200 has generally cylindrical body, housing, or casing 202 including a lower casing or first portion 204 and an upper casing, bonnet, or second portion 206. The first and second portions 204 and 206 are threadably engaged via respective mating threads 208 and 210. The first portion 204 includes an inlet port 212 having internal threads 214 to engage a pipe or other fluid carrying conduit. Additionally, a filter or screen 216 is provided in the inlet 212 to prevent dirt and/or other debris from contaminating the regulator and impairing its operation. The first portion 204 also holds or guides a valve assembly 218. The valve assembly 218 includes a fluid flow control member or plug 220 that moves relative to an opening or orifice 222 of a passage 224, which is fluidly coupled to the inlet 212, to control the flow of fluid into the regulator 200. The fluid flow control member or plug 220 is fixed to a stem 226 that is slidably engaged with a bore 228 in the first housing portion 204. An o-ring 230 forms a circumferential seal between the wall of the bore 228 and the stem 226. The stem 226 is integrally formed with a piston 232 that is slidably engaged within the upper or second casing portion 206. An o-ring 234 provides a seal against an inner wall 236 of the upper or second casing portion 206. An upper surface 238 of the piston 232 is fluidly coupled to an outlet pressure port 240, which includes internal threads 242 for receiving a pipe or other fluid conduit.

In contrast to known fluid regulators, in the example fluid regulator 200, includes a compression spring 248 is disposed between a spring plate 250 and the piston 232. The spring plate 250 is slidably movable along the longitudinal axis of the stem 226. To guide and facilitate the sliding of the spring plate 250, the spring plate 250 may include tabs or projections 252 and 254 that slide within an opening or channel 256 of the body or housing 202. To enable adjustment of the control pressure of the example fluid regulator 200, an adjusting ring 258 is provided. The adjusting ring 258 may be threadably engaged via threads 260 and 262 to the lower or first portion 204 of the body or housing 202 so that rotation of the adjusting ring 258 moves the spring plate 250 toward the piston 232 to increase the compression of the spring 248, which increases the regulated output pressure of the fluid regulator 200, or away from the piston 232 to decrease the compression (i.e., enable expansion) of the spring 248, which decreases the regulated output pressure of the fluid regulator 200. Thus, as can be clearly seen in FIG. 2, the example fluid regulator 200 provides a relatively compact adjustable in-line one-stage fluid regulator configuration that provides an adjuster that enables, for example, manual field adjustment (e.g., via the ring 258) of the regulated outlet or output pressure of the regulator 200.

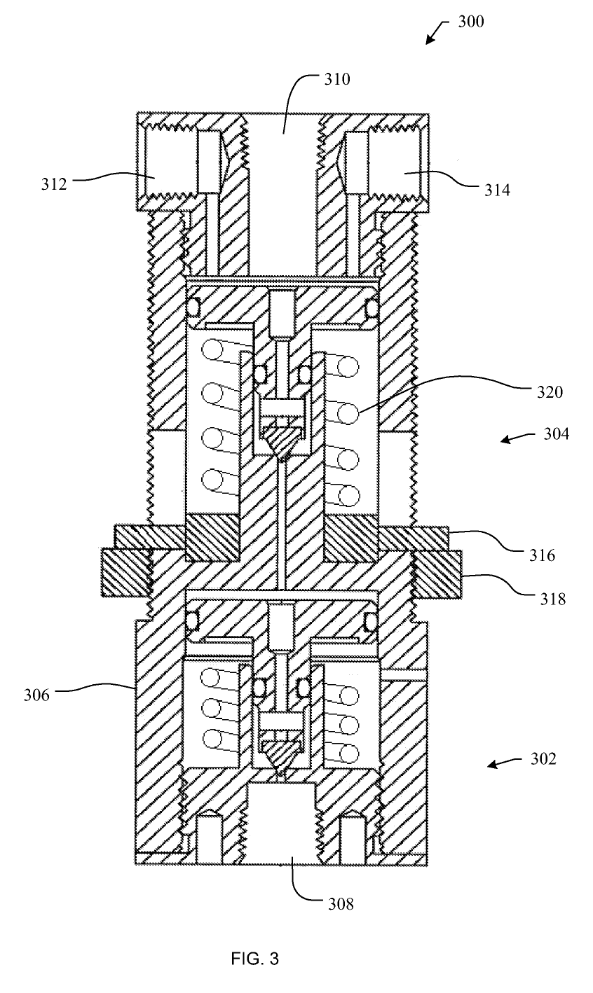

FIG. 3 depicts a cross-sectional view of an example two-stage in-line adjustable fluid regulator 300. In general, the example regulator 300 includes a first non-adjustable regulator 302 that is fluidly serially coupled to an adjustable second stage regulator 304. The first and second regulators or stages 302 and 304 are integrated within a housing or casing 306 having an inlet 308 and a plurality of outlets 310, 312, and 314. One or more of the outlets 310, 312, and 314 may be used as needed to suit various applications and any unused ones of the outlets 310, 312, and 314 may be plugged or blocked or otherwise sealed. As described in connection with the adjustable regulator 200 of FIG. 2, the second stage 304 provides an adjustable outlet regulation pressure via a movable spring plate 316 and adjusting ring 318. Thus, the adjusting ring 318 is threadably engaged with the housing or casing 306 so that rotation of the ring 318 in one direction causes the spring plate 316 to move toward the outlets 310, 312, and 314 to compress a spring 320 and increase the regulated output pressure at the outlets 310, 312, and 314. Similarly, rotation of the ring 318 in the other direction causes the spring plate 316 to move away from the outlets 310, 312, and 314 to decrease the compression on the spring 320 and reduce the regulated output pressure at the outlets 310, 312, and 314.

While the example adjustable in-line fluid regulators 200 and 300 described herein are depicted as being generally cylindrically-shaped, any other shape(s) could be used instead. For example, the casings or bodies used may have a polygonal (e.g., rectangular) cross-section. Additionally, while the adjusting ring mechanisms described herein are depicted as being directly, manually adjustable, any variety of gearing and/or electromechanical adjustment mechanism(s) may alternatively or additionally be employed to facilitate movement of the spring plates 250 and 316. For example, a small electric motor may be coupled (e.g., via gears or the like) to the adjusting ring to rotate the ring and adjust the position of the spring plates 250 and 316 by activating the motor. Still further, one or more locking rings may be used in addition to the adjusting rings 250 and 316 to enable the position(s) of the adjusting rings 250 and 316 to be mechanically fixed or locked in place (e.g., by counter-tightening the locking ring(s) against the adjusting ring). Additionally, the adjusting and/or locking rings may include multiple flats or other features to facilitate the use of tools (e.g., wrenches, pliers, etc.) to turn or rotate the adjusting rings.

Although certain apparatus have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. An adjustable fluid regulator, comprising:
a body having a fluid inlet and a fluid outlet; and
a first fluid regulator comprising:
a valve to control a flow of fluid from the inlet to the outlet;
a piston coupled to the valve via a stem, wherein the piston is to receive a pressure associated with the outlet;
a spring plate movable along a longitudinal axis of the stem;
a spring disposed between the piston and the spring plate; and
an adjuster engaged with the body to move the spring plate to change a compression of the spring and a regulated outlet pressure of the fluid regulator.

2. An adjustable fluid regulator as defined in claim 1, wherein the body comprises a first portion threadably engaged to a second portion.

3. An adjustable fluid regulator as defined in claim 1, wherein the body comprises an opening to guide movement of the spring plate.

4. An adjustable fluid regulator as defined in claim 1, wherein the adjuster comprises a ring engaged with the body so that rotation of the ring moves the spring plate along a longitudinal axis of the stem.

5. An adjustable fluid regulator as defined in claim 4, wherein the ring is threadably engaged with the body.

6. An adjustable fluid regulator as defined in claim 1, further comprising a second fluid regulator serially fluidly coupled to the first fluid regulator.

7. An adjustable fluid regulator as defined in claim 6, wherein the first and second fluid regulators form an in-line fluid regulator.

8. An adjustable fluid regulator as defined in claim 6, wherein the second fluid regulator is fluidly coupled between the inlet and the first fluid regulator.

9. An adjustable fluid regulator as defined in claim 6, wherein the second fluid regulator has a predetermined non-adjustable regulation pressure.

10. An adjustable fluid regulator as defined in claim 6, wherein the first and second fluid regulators are integrated within the body.

11. An adjustable fluid regulator assembly, comprising:
A first fluid regulator and a second fluid regulator fluidly coupled to the first fluid regulator, wherein the first and second fluid regulators comprise an in-line, two-stage fluid regulator, wherein the first fluid regulator form an adjuster to change a fluid regulation pressure of the first fluid regulator, and wherein the adjuster is configured to be field adjustable to change a compression of a spring of the first fluid regulator.

12. An adjustable fluid regulator as defined in claim 11, wherein the adjuster comprises a rotatable ring and a spring plate, and wherein rotation of the ring causes the spring plate to move to either compress the spring or enable expansion of the spring.

13. An adjustable fluid regulator as defined in claim 11, wherein the adjuster is disposed between an inlet and an outlet of the adjustable fluid regulator.

14. An adjustable fluid regulator as defined in claim 11, wherein each of the first and second fluid regulators comprises a piston and a stem coupled to the piston.

15. An adjustable fluid regulator as defined in claim 11, wherein each of the first and second fluid regulators comprises a spring to set an output regulation pressure.

16. An adjustable fluid regulator as defined in claim 11, wherein the first and second fluid regulators are disposed in a substantially cylindrical body.

17. An adjustable fluid regulator as defined in claim 11, wherein the adjuster is threadably engaged with an outer surface of the adjustable fluid regulator to enable movement of the adjuster along a longitudinal axis of the body.

18. An adjustable fluid regulator as defined in claim 11, wherein the adjuster is manually adjustable.

19. An adjustable fluid regulator as defined in claim 11, wherein the adjustable fluid regulator comprises an inlet and a plurality of outlets.

20. An adjustable fluid regulator as defined in claim 11, wherein the compression of the spring is associated with a desired output regulation pressure.
